(19) United States
(12) Patent Application Publication
(10) Pub. No.: US 2007/0270203 A1
(43) Pub. Date: Nov. 22, 2007

(54) Gaming machine and gaming system

(75) Inventor: Eiji Aida, Zama (JP)

Correspondence Address: GLOBAL IP COUNSELORS, LLP, 1233 20TH STREET, NW, SUITE 700, WASHINGTON, DC, 20036-2680, US

(73) Assignee: Konami Gaming, Incorporated, Las Vegas, NV (US)

(21) Appl. No.: 11/797,187

(22) Filed: May 1, 2007

(30) Foreign Application Priority Data
May 16, 2006 (JP) 2006-135948

(51) Int. Cl. A63F 13/00

(52) U.S. Cl. 463/16; 463/26

(57) ABSTRACT

In a gaming machine of the present invention, a holder unit removably holds a portable storage device having a display unit and a storage unit in a position where the screen of the display unit is visible to a player. A reader unit reads storage contents from the storage unit. A data processor unit processes the storage contents. The gaming machine can use not only the storage contents stored in the storage unit, but also the display unit to provide a player with various additional information in a text or graphic form with visual effects for games. The gaming machine includes a display controller unit, which controls the display unit as a sub-display device to complement a game display unit that displays a game screen. The display controller unit may change images displayed on the screen of the display unit depending on the game status.

### CROSS-REFERENCE TO RELATED APPLICATIONS

This application claims priority to Japanese Patent Application No. 2006-135948, filed on May 16, 2006. The entire disclosure of Japanese Patent Application No. 2006-135948 is hereby incorporated herein by reference.

### BACKGROUND OF THE INVENTION

1. Field of the Invention

The present invention relates to a gaming machine that can read and use storage contents from a portable storage device.

2. Background Information

A gaming machine installed in an amusement arcade, a pachinko parlor, a casino, or a home gaming machine is known which reads and uses storage contents from a portable storage device. For example, there is a gaming machine installed especially in a casino, which is used to provide players with a number of points as a service depending on the money that they have spent for game plays in the casino. Each player is issued with a house card before game plays in exchange for registration to a server in the casino. The house card is a portable storage device usable within the casino. The house card stores identification data of itself (card ID) or the player (player ID). The player first inserts his/her house card into a card slot mounted on the gaming machine at the start of game play thereon. The gaming machine then reads the card/player ID from the house card, and uses it to increase the player's points stored in the server depending on the game plays. The server thus keeps track of the total number of the players' points. The player can be provided with bonuses such as free accommodation coupons, depending on the total number of the points.

Another gaming machine, especially a pachinko machine installed in a pachinko parlor, allows a prepaid card to be used in game plays. The gaming machine reads the monetary information from the prepaid card inserted therein, and uses the player's money indicated by the monetary information in game play (e.g. allows the player to use a number of pachinko balls).

A gaming machine, especially installed in an amusement arcade, or a home gaming machine allows a portable storage device to save game data for the next game play. The player first places his/her portable storage device on a holder mounted on the gaming machine at the start of the next game play thereon. The gaming machine then reads the game data from the portable storage device, and uses it to restart the game from where the player has stopped previously.

On the other hand, a portable storage device is known which comprises a display unit in addition to a storage unit (cf. Japan Published Patent Applications Nos. 2003-330829 and 2006-004311). This portable storage device is generally in the shape of a card. At least a portion of the surface of the card is used as the screen of the display unit. Various images can be displayed on the screen. This will expand the range of uses of the portable storage device. Accordingly, it is desired that gaming machines can use the portable storage devices with display units. In particular, it is desired that the gaming machine can appropriately use the display function of the portable storage device.

In view of the above, it will be apparent to those skilled in the art from this disclosure that there exists a need for an improved gaming machine that can use a portable storage device comprising a display unit, and in particular, use the display function thereof. This invention addresses this need in the art as well as other needs, which will become apparent to those skilled in the art from this disclosure.

### SUMMARY OF THE INVENTION

A gaming machine according to the present invention comprises a game controller unit, a holder unit, a reader unit, and a data processor unit. The game controller unit is configured to conduct a game. Here, the gaming machine may be configured to communicate with an external server, and collaborate with the server to establish a download or thin-client gaming system. Especially in the thin-client gaming system, the game controller unit may be installed in the server instead of the gaming machine. The holder unit is configured to removably hold a portable storage device comprising a display unit and a storage unit, in a position where the screen of the display unit is visible to a player. The holder is preferably a pad or a slot that allows the portable storage device to be placed thereon or therein. The holder may wirelessly communicate with the portable storage device. The display unit preferably comprises a piece of electric paper, or alternatively may comprise an LCD, an OLED, or other types of display devices. The reader unit is configured to read storage contents from the storage unit. The data processor unit is configured to process the storage contents.

In contrast to prior art gaming machines, the gaming machine according to the present invention can use not only the storage contents stored in the portable storage device, but also the display unit thereon to provide a player with various additional information in a text or graphic form and visual effects for games. Here, the gaming machine preferably comprises a display controller unit configured to control the display unit. The gaming machine more preferably comprises a game display unit configured to display a game screen. Accordingly, the gaming machine preferably uses the display unit on the portable storage device as a sub-display device that complements the game display unit. The display controller unit may be configured to change images displayed on the screen of the display unit depending on the game status. The gaming machine can thus enhance the flexibility and variety in design of game functions, visual effects (e.g. a game screen), and additional services (e.g. a point service and a prepaid card service). This enables the gaming machine to attract a larger number of players.

The gaming machine according to the present invention preferably comprises a power supply unit configured to provide the portable storage device with power. Here, the holder may wirelessly transmit power to the portable storage device. The portable storage device can thus maximize its performance by using the sufficiently high power.

The gaming machine according to the present invention preferably comprises an image scanner unit and an image processor unit. The image scanner unit is configured to scan at least a portion of images from the screen of the display unit. The image processor unit is configured to process the image data captured by the image scanner unit. The gaming machine may reproduce the images from the captured image data on the screen of another display device (e.g., the game display unit) in addition to other images. Alternatively, the images to be scanned may include letters, numbers, symbols, diagrams, pictures, a bar code, and a matrix code. The gaming machine can thus decode various data from the captured image data in addition to the storage contents read from the portable storage device, like monetary information printed on a ticket used in a ticket-in system. When the gaming machine comprises a display controller unit configured to control the display unit, the image processor unit is preferably configured to detect an error in the images displayed on the screen of the display unit under control of the display controller unit from the image data captured by the image scanner unit. In particular, the image processor unit is configured to check if the images actually displayed on the screen are matched with the images that the display controller unit intends to display on the screen. The gaming machine can thus ensure high reliability and security of the images displayed on the screen, even if the portable storage device wirelessly receives the image data.

The gaming machine according to the present invention preferably comprises a console unit, a credit memory unit, a sub-credit memory unit, a credit manager unit, and a display controller unit. The console unit is configured to accept a bet from a player. The credit memory unit is configured to store credit data that indicates the amount of credits. Here, credits are actually used in game plays as follows. The game controller unit is configured to update the credit data to decrease the amount of the credits by the amount of the bet at the start of a game, and increase the amount of the credits by a payout provided to the player depending on the amount of the bet and the game result. The sub-credit memory unit is configured to store sub-credit data that indicates the amount of sub-credits. Both the credit and sub-credit memory unit may be assigned to the regions in the same memory device. Here, sub-credits mean auxiliary credits stored in the gaming machine in addition to credits. The credit manager unit is configured to update the credit data and the sub-credit data to transfer a predetermined amount from the sub-credits to the credits. When being short of credits, a player can use sub-credits to increase the credits instead of inserting cash into the gaming machine. This facilitates the game play on the gaming machine. The display controller unit is preferably configured to cause the display unit to display the amount of sub-credits. Here, the amount of credits is usually displayed on a game screen. Accordingly, the amounts of credits and sub-credits are separately displayed on different screens. This can cause the player to clearly discriminate between the credits and the sub-credits.

The gaming machine according to the present invention preferably comprises a server interface unit configured to communicate with a server. In this case, the reader unit is preferably configured to read identification data from the storage unit. The data processor unit is preferably configured to cause the server interface unit to transmit the identification data to the server and receive auxiliary credit data from the server in response to the identification data. The data processor unit is further configured to update the sub-credit data to increase the amount of the sub-credits by the amount that the auxiliary credit data indicates. Especially in a casino or the like, the gaming machine is preferably connected to the server. Each player preferably entrusts his/her money to the casino before he/she starts game play in the casino. The server stores auxiliary credit data indicating the amount of the money, and links it to identification data assigned to the player. The gaming machine reads the identification data from the portable storage device, and uses it to request the transmission of the auxiliary credit data to the server. The server receives the identification data from the gaming machine, and uses it to verify the player and retrieve the requested auxiliary credit data. The gaming machine then receives the auxiliary credit data from the server, and uses it as the sub-credit data. The gaming machine thus collaborates with the server to allow players to play games thereon quickly without inserting cash thereinto.

Alternatively, the gaming machine according to the present invention may comprise a point memory unit, a point manager unit, and a display controller unit. The point memory unit is configured to store point data indicating a number of points. Here, the points are provided for players as a service depending on the money that they have spent for game plays on the gaming machine. The game controller unit preferably determines the number of the points depending on the game plays. The point manager unit is configured to update the point data to increase the points by the number determined by the gaming controller unit. The display controller unit is configured to cause the display unit to display the number of the points. Accordingly, the number of the points is separately displayed on a screen different from a game screen. Like this, the gaming machine can use the display unit of the portable storage device as a sub-display device to display auxiliary data separately from game data. This facilitates more effective use of a game screen, and accordingly the gaming machine can attract a larger number of players.

The gaming machine according to the present invention preferably comprises a server interface unit configured to communicate with a server. In this case, the reader unit is preferably configured to read identification data from the storage unit. The data processor unit is preferably configured to cause the server interface unit to transmit the identification data to the server and receive total point data from the server in response to the identification data. The data processor unit is further configured to update the point data to increase the number of the points by the number that the total point data indicates. Especially in a casino or the like, the gaming machine is preferably connected to the server. The server stores total point data indicating the total number of points that each player has been provided, and links the total point data to identification data assigned to the player. The gaming machine reads the identification data from the portable storage device, and uses it to request the transmission of the total point data to the server. The server receives the identification data from the gaming machine, and uses it to verify the player and retrieve the requested total point data. The gaming machine then receives the total point data from the server, and updates it to increase the points indicated thereby. Here, the server usually keeps track of the total number of points of each player, and provide the player with bonuses depending on the total number. The gaming machine allows players to check the current number of their points thereon at each game play.

These and other objects, features, aspects and advantages of the present invention will become apparent to those skilled in the art from the following detailed description, which, taken in conjunction with the annexed drawings, discloses a preferred embodiment of the present invention.

### BRIEF DESCRIPTION OF THE DRAWINGS

Referring now to the attached drawings which form a portion of this original disclosure:

FIG. 1 is a functional block diagram of the main configuration of a gaming system for a casino according to an embodiment of the present invention;

FIG. 2 is a block diagram of the hardware configuration of a server comprised in the gaming system shown in FIG. 1;

FIG. 3 is a perspective view of the appearance of a gaming machine shown in FIG. 1;

FIG. 4 is a block diagram of the hardware configuration of a main control board comprised in the gaming machine shown in FIG. 1;

FIG. 5 is a block diagram of the hardware configuration of a sub-control board comprised in the gaming machine shown in FIG. 1;

FIG. 6 is perspective views of the appearances of a card holder and a house card used in the gaming machine shown in FIG. 3;

FIG. 7 is a cross sectional view of the house card shown in FIG. 6A;

FIG. 8 is a flow chart of a slot game conducted by the gaming machine shown in FIG. 1;

FIG. 9 is an example of a game screen which shows a pattern of stopped symbols and winning combinations;

FIG. 10 is a flow chart of a process of the gaming machine shown in FIG. 1 that receives sub-credit data and total point data from the server shown in FIG. 1;

FIG. 11 is a flow chart of a process of the gaming machine shown in FIG. 1 that transfer sub-credits to credits;

FIG. 12 is a flow chart of a process of the gaming machine shown in FIG. 1 that transmits credit data and point data to the server shown in FIG. 1; and

FIG. 13 is a cross sectional view of the card slot and the house card shown in FIG. 6A.

### DETAILED DESCRIPTION OF THE PREFERRED EMBODIMENT

A preferred embodiment of the present invention will now be explained with reference to the drawings. It will be apparent to those skilled in the art from this disclosure that the following description of the preferred embodiment of the present invention is provided for illustration only and not for the purpose of limiting the invention as defined by the appended claims and their equivalents.

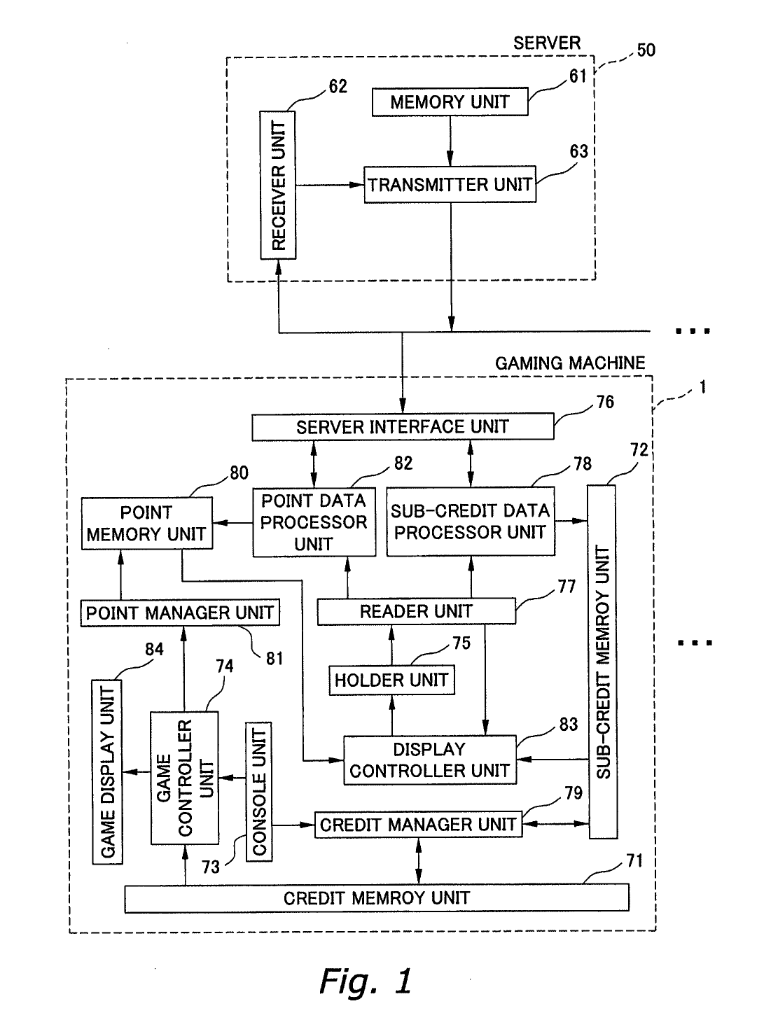

A preferred embodiment of the present invention is a gaming system preferably installed in a casino (cf. FIG. 1). As shown in FIG. 1, the gaming system comprises a plurality of gaming machines 1 and a server 50. The gaming machines 1 are placed on the casino floors. The server 50 is placed in a security room off-limits to players and locked by casino managers. Each of the gaming machines 1 and the server 50 communicate with each other through a communication network. When some or all of the functions of the server 50 are placed far away from the casino, the communication network can include a public telephone line, a leased telephone line, a cable television line, and a wireless communications line.

The gaming system shown in FIG. 1 is of a standalone or download type, i.e., each gaming machine 1 is equipped with a game controller unit. The gaming machines 1 themselves conduct various types of games (preferably, slot games). Alternatively, the gaming system may be of a thin-client type, i.e., the server 50 may be equipped with a game controller unit. The gaming system controls games conducted on each gaming machine 1 through the network.

### Configuration of the Server 50

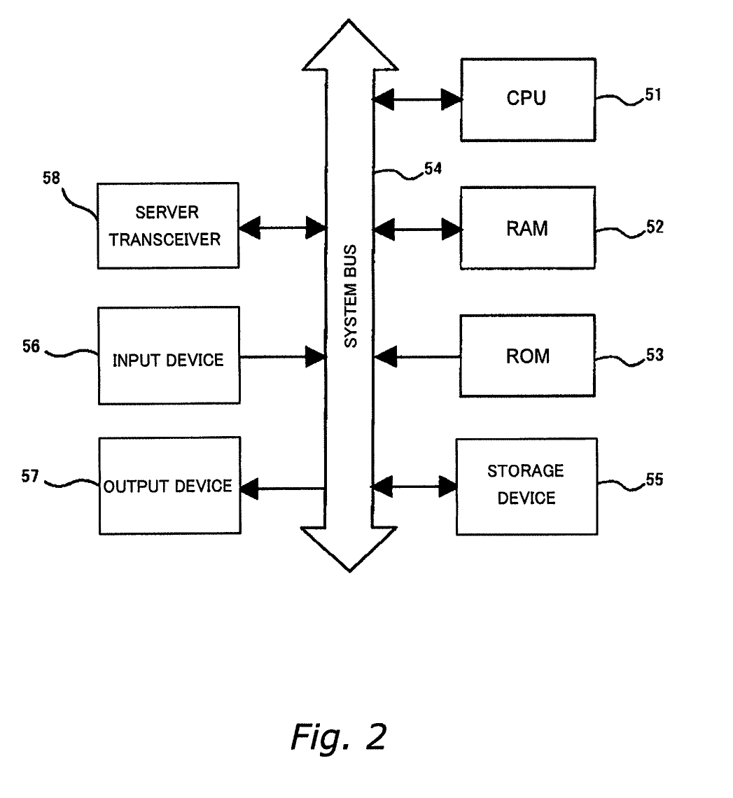

FIG. 2 shows the hardware configuration of the server 50. As shown in FIG. 2, the server 50 comprises a CPU 51, a RAM 52, a ROM 53, a system bus 54, a storage device 55, an input device 56, an output device 57, a server transceiver 58, and the like. These components exchange data and commands of programs with each other through the system bus 54. The ROM 53 and the storage device (preferably, one or more HDDs) 55 store programs for operations of the server 50 using predetermine procedures. The programs are invoked into the CPU 51 or the working area of the RAM 52 and then executed. In a download- or thin-client-type gaming system, the storage device 55 may also store many types of game programs available to the gaming machines 1.

The storage device 55 in particular stores auxiliary credit data and total point data. The storage device 55 links the data to identification data. The auxiliary credit data indicates the amount of money that each player has entrusted to the casino before he/she starts game play. The total point data indicates a number of points provided for each player depending on the money that he/she has spent for game play in the casino. The identification data is assigned to each house card (i.e., card ID). The house card is a card-shaped portable storage device, e.g., an IC card and a memory card. Other types of portable storage device, e.g., a mobile phone, a PDA, or a portable gaming device may be used instead of the house card. The house card has been issued to each player before game plays in exchange for registration of his/her personal information to the server 50 in the casino. Accordingly, the card ID stored in the house card can be treated to identify the player issued with the house card. Alternatively, a specific player ID may be assigned to each player, and stored in the house card issued to the player. The storage device 55 allows a casino-employed operator to enter the auxiliary credit data and the personal information by using the input device 56 such as a mouse, a keyboard, and the like. The operator can check the input data stored in the storage device 55 through the output device 57 visual data on the screen of a display device, or printed data on a piece of paper ejected from a printer, for example.

The above-described hardware components of the server 50 mainly include a memory unit 61, a receiver unit 62, and a transmitter unit 63. The RAM 52, the ROM 53, and the storage device 55 constitute an example of the memory unit 61. The memory unit 61 manages auxiliary credit data and total point data based on the links to identification data (preferably, card IDs). The receiver unit 62 and the transmitter unit 63 consist of the CPU 51, the RAM 52, the ROM 53, and the server transceiver 58. The receiver unit 62 receives identification data (preferably, a card ID) from one of the gaming machines 1 through the network. The transmitter unit 63 retrieves from the memory unit 61 the auxiliary credit data and/or the total point data linked to the identification data that the receiver unit 62 has received. The transmitter unit 63 then transmits the auxiliary credit data and/or the total point data to the gaming machine 1 through the network.

These three functional units preferably operate as follows. When the receiver unit 62 receives a request for auxiliary credit data and/or total point data from one of the gaming machines 1, the receiver unit 62 extracts the card ID from the request. The transmitter unit 63 then retrieves the requested auxiliary credit data and/or total point data by using the card ID extracted by the receiver unit 62. The transmitter unit 63 transmits the auxiliary credit data and/or total point data to the gaming machine 1. When the receiver unit 62 receives a command for increasing auxiliary credits and/or total points from one of the gaming machines 1, the receiver unit 62 extracts the card ID from the command. The memory unit 61 then retrieves the corresponding auxiliary credit data and/or total point data by using the card ID extracted by the receiver unit 62. The memory unit 61 updates the auxiliary credit data and/or total point data to increase auxiliary credits and/or total points, respectively, according to the command from the gaming machine 1.

Note that the server 50 may be a special-purpose controller, or a general-purpose computer system. The server 50 may be a single computer, or a group of computers which are linked to each other and serve separate functions through a network.

### Configuration of the Gaming Machine 1

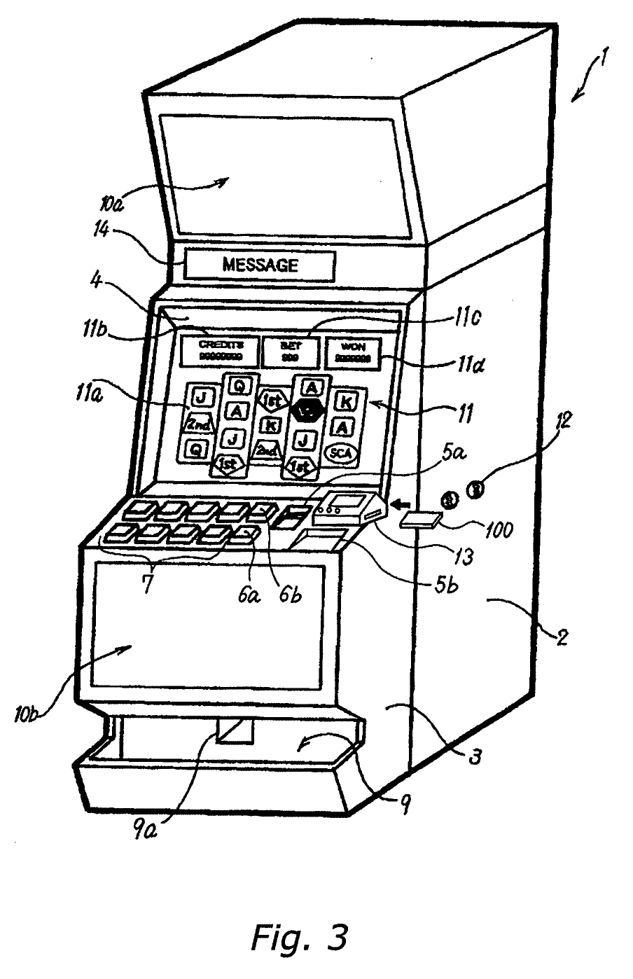

The gaming machines 1 provide players with various types of games, preferably, slot games. As shown in FIG. 3, a gaming machine 1 comprises a box-shaped cabinet 2, and a front panel 3 that is coupled to the front of the cabinet 2 and capable of being opened and closed. On the front panel 3 are provided, for example, a display window 4, a coin slot 5a, a bill slot 5b, a spin button 6a, a cash out button 6b, bet buttons 7, a coin tray 9, lamps 10a and 10b, a card holder 13, and a sub-monitor 14. A monitor 11 is placed inside the cabinet 2, and visible through the display window 4. The monitor 11 serves as a game display unit, i.e., displays a game screen in various patterns depending on the game status. The monitor 11 preferably uses a liquid crystal display panel, or alternatively, may use a cathode-ray tube, a plasma display panel, or an organic LED panel. A player uses the bet buttons 7 to select paylines and place bets thereon. The buttons 6a, 6b, and 7 are preferably lamp buttons including light emitting devices which emit light when pushed. Alternatively, one or more of the buttons 6a, 6b, and 7 may be replaced with one or more touch panels installed on the monitor 11 or other display devices. Coins are discharged from a coin chute 9a, and then stored in the coin tray 9. The card holder 13 has a card slot 13a on a side, into which a house card 100 can be inserted. In particular, the card holder 13 can removably hold the house card 100, which comprises a display unit 100b in addition to a storage unit 100a, in a position where the screen of the display unit is visible to a player, thereby capable of effectively using the display function of the house card 100 (details will be described below). The sub-monitor 14 displays auxiliary information other than game information, e.g., a welcome message. The sub-monitor 14 preferably uses an LCD, or alternatively, may be a CRT, a PDP, or an OLED.

A game screen displayed on the monitor 11 preferably comprises five symbol display areas 11a. A column of various symbols (a video reel) is arranged in a predetermined order on each of the symbol display areas 11a. The game screen also comprises a credit display area 11b, a bet display area 11c, and an award display area 11d above the symbol display areas 11a. The amount of credits available to a player appears in the credit display area 11b. The amount of a bet that the player has placed appears in the bet display area 11c. The amount of an award that the player has won as a game result appears in the award display area 11d.

A coin counter, a coin acceptor, a coin payout device, and a speaker are installed inside the cabinet 2 (not shown in FIG. 3). The coin counter counts the amount of coins and bills inserted into the coin slot 5a and the bill slot 5b, respectively. The coin acceptor validates the coins and bills. The coin payout device comprises a hopper and can hold a large number of coins.

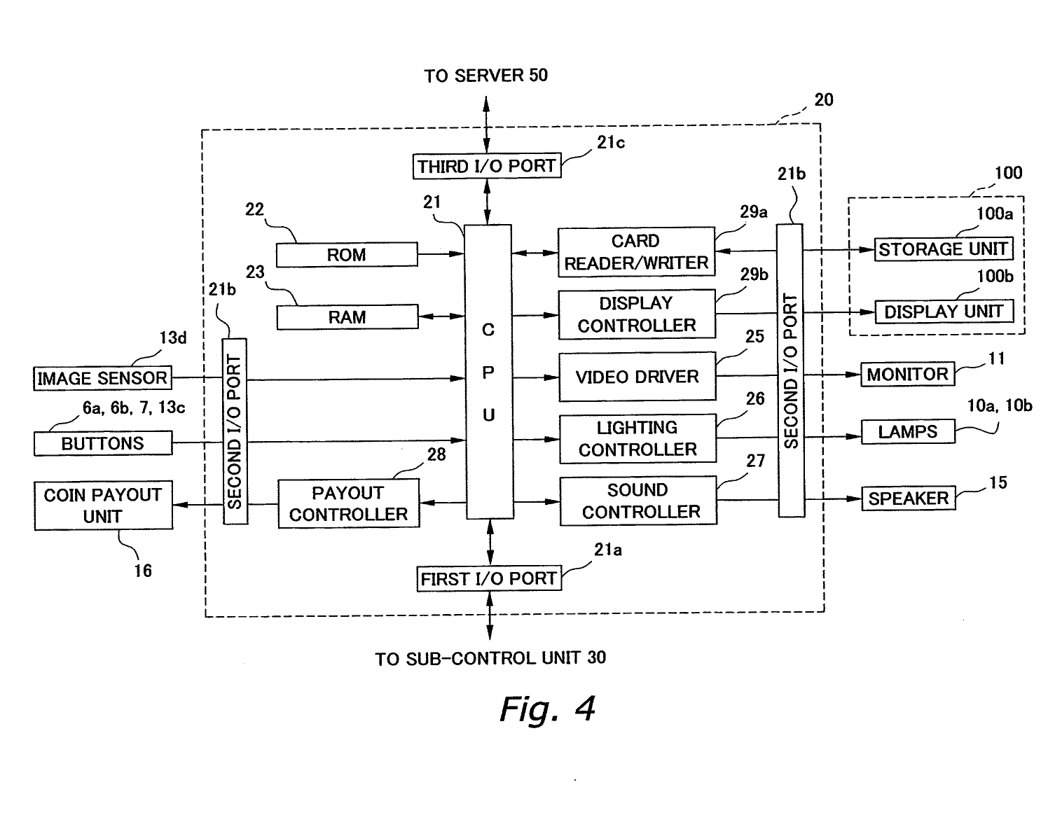

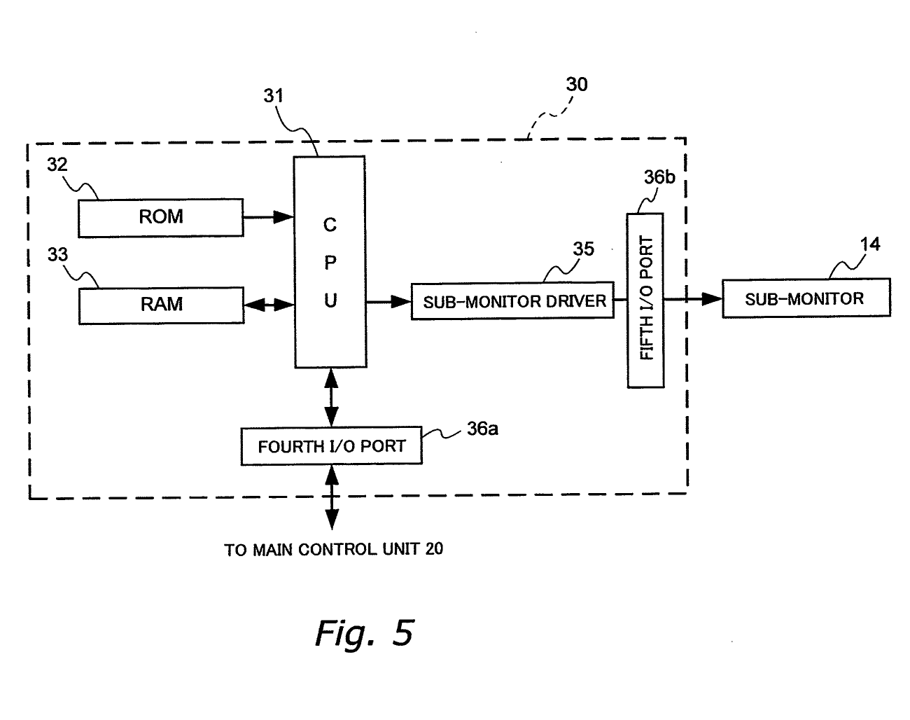

The gaming machine 1 comprises a main control board 20 and a sub-control board 30 (cf. FIGS. 4 and 5, respectively). As shown in FIG. 4, the main control board 20 comprises a main CPU 21, a first I/O port 21a, a second I/O port 21b, a third I/O port 21c, a main ROM 22, a main RAM 23, a video driver 25, a lighting controller 26, a sound controller 27, a payout controller 28, a card reader/writer 29a, and a display controller 29b. The first I/O port 21a is used in communication between the main control board 20 and the sub-control board 30. The second I/O port 21b is used in communication between the main control board 20 and external devices, e.g., the monitor 11, the lamps 10a, 10b, the speaker 15, the various buttons 6a, 6b, 7, the coin counter/acceptor, the coin payout unit 16, and the house card 100. The third I/O port 21c is used in communication between the main control board 20 and the server 50 through the communications network. The main ROM 22 stores various programs, e.g., a communications program. The main CPU 21 invokes the programs. The main RAM 23 temporally stores results computed by the main CPU 21. The video driver 25 controls the display on the monitor 11 under control of the main CPU 21. The lighting controller 26 switches the lamps 10a and 10b on and off under control of the main CPU 21. The sound controller 27 controls the speaker 15 to reproduce voice announcements, sound effects, and the like under control of the main CPU 21. The payout controller 28 controls the coin payout unit 16 to supply a proper amount of coins through the coin chute 9a to the coin tray 9 under control of the main CPU 21. The card reader/writer 29a reads and writes data from and into the storage unit 100a of the house card 100 inserted in the card slot 13a under control of the main CPU 21. In the case where the house card 100 comprises the display unit 100b in addition to the storage unit 100a, the display controller 29b controls the display unit 100b under control of the main CPU 21. The main CPU 21 is connected to the spin button 6a, the cash out button 6b, and the bet buttons 7, and transmits operation signals through the second I/O port 21b. Moreover, the main CPU 21 is also connected to a coin counter (not shown in figures) that counts the amount of cash inserted into the coin slot 15a and the bill slot 5b. The main CPU 21 is also connected to an image sensor 13d, which is mounted on the card slot 13, and receives output signals from the image sensor 13d through the second I/O port 21b.

As shown in FIG. 5, the sub-control board 30 comprises a sub-CPU 31, a sub-ROM 32, a sub-RAM 33, a sub-monitor driver 35, a fourth I/O port 36a, and a fifth I/O port 36b. The sub-ROM 32 stores various programs and various databases. The sub-CPU 31 invokes the programs, and accesses the databases. The sub-RAM 33 temporally stores results computed by the sub-CPU 31. The sub-monitor driver 35 controls the sub-monitor 14 under control of the sub-CPU 31. The fourth I/O port 36a is used in data communication between the main control board 20 and the sub-control board 30. The fifth I/O port 36b is used in data communication between the sub-monitor 14 and the sub-control circuit board 30.

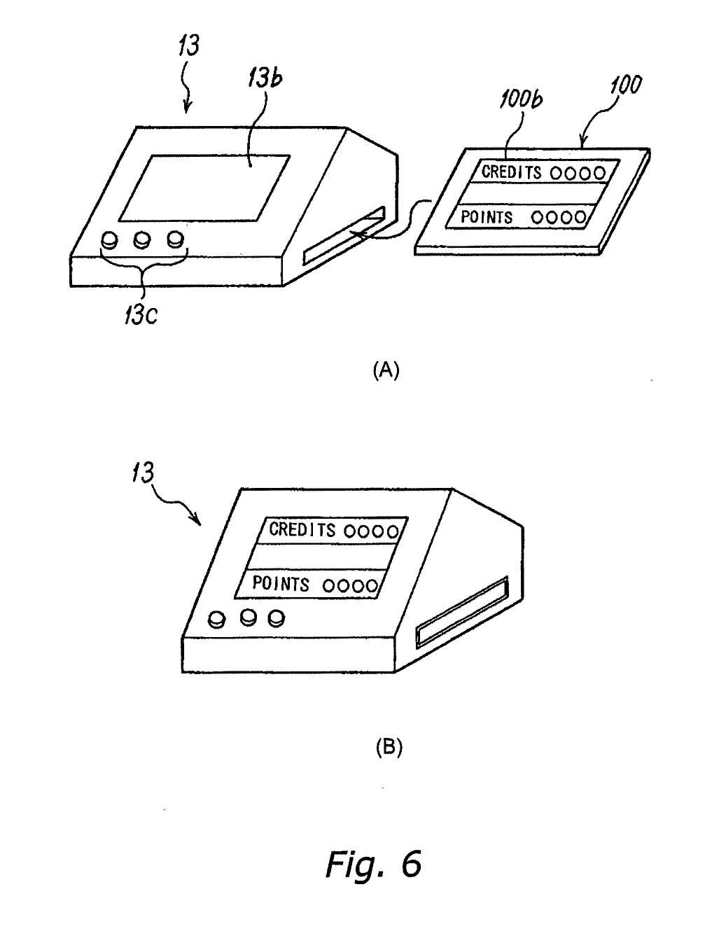

FIG. 6 shows perspective views of the appearances of the card holder 13 and the house card 100. The card holder 13 preferably comprises a transparent sub-display window 13b and operational buttons 13c mounted on the top, in addition to the card slot 13a mounted on the side. The house card 100 preferably comprises the storage unit 100a and the display unit 100b. The card holder 13 preferably holds the house card 100 in a horizontal position, and in particular locates the screen of the display unit 100b in a position visible through the sub-display window 13b (cf. FIG. 6B).

The display unit 100b preferably displays various data about a player himself/herself, in particular, the amount of his/her sub-credits and the number of his/her points on the screen. The amounts of such data, i.e., auxiliary data other than game data are generally small. Accordingly, the display unit 100b is appropriate to be used to display the auxiliary data, even if its screen size is limited by the miniaturization of the house card 100. This can eliminate the auxiliary data from a game screen (e.g., the symbol display areas 11a), and enhance the size and the flexibility in design of the game screen.

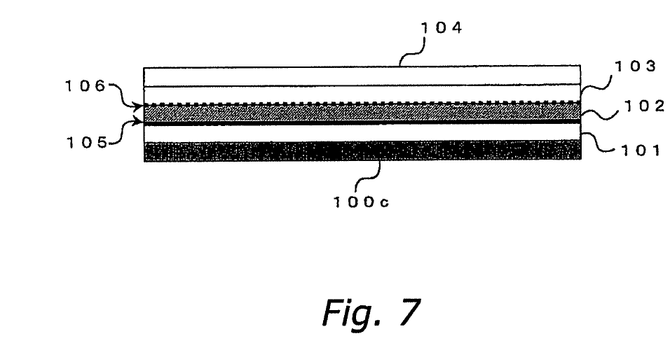

The display unit 100b preferably includes a piece of electric paper laminated on a base substrate 100c of the house card 100 as shown in FIG. 7. The display unit 100b comprises four laminated layers; a lower transparent substrate layer 101, an image recording layer 102, an upper transparent substrate layer 103, and a protective layer 104. Lower electrodes 105 are sandwiched between the lower transparent substrate layer 101 and the image recording layer 102, and upper electrodes 106 are sandwiched between the image recording layer 102 and the upper transparent substrate layer 101. The lower electrodes 105 comprise a plurality of parallel lines that run in the longitudinal direction of the house card 100. The upper electrodes 106 comprise a plurality of parallel lines that run in the transverse direction of the house card 100, and cross the lines of the lower electrodes 105 at substantially right angle within the screen of the display unit 100b. Each intersection between the electrodes 105 and 106 configures a pixel. The edges of the lines are connected to pads mounted on an edge of the house card 100.

When the house card 100 is placed in the card holder 13, the pads of the house card 100 will touch pads mounted inside the card holder 13, which are connected to the display controller 29b (cf. FIG. 4). The display controller 29b then activates the lower and upper electrodes 105 and 106 with appropriate timing, and thereby controls voltages between the electrodes 105 and 106.

The image recording layer 102 changes light reflectivity or transmissivity at the pixels, i.e., the intersections between the electrodes 105 and 106 depending on the voltages therebetween. The image recording layer 102 preferably comprises a plurality of transparent microcapsules at each pixel. Each microcapsule is filled with white and black fine particles charged in opposite polarities, preferably, negative and positive polarities, respectively. When the display controller 29b applies positive and negative voltages to a lower electrode 105 and an upper electrode 106, respectively, an electric field will be generated at the pixel where the electrodes 105 and 106 cross each other in the direction from the lower electrode 105 to the upper electrode 106. Then, in each microcapsule located at the pixel, the white and black particles move in opposite directions and accumulate on the opposite sides of the microcapsule near the lower electrode 105 and the upper electrode 106, respectively. As a result, the pixel appears in black. Conversely, when the display controller 29b applies negative and positive voltages to the lower electrode 105 and the upper electrode 106, respectively, the pixel appears in white. Furthermore, the display controller 29b can change the gray scale of the pixel in two or more steps by adjusting the difference between the negative and positive voltages. In this manner, the display controller 29b determines the gray scale of each pixel, and thereby reproduces a monochrome image on the screen of the display unit 100b. Since the separate arrangement between the white and black particles is maintained after power is cut to the house card 100, the monochrome image is maintained after the house card 100 is removed from the card holder 13.

Note that the display unit 100b may be configured to be able to display color images. Color filters are preferably sandwiched between the upper transparent substrate layer 103 and the protective layer 104. More preferably, red, green, and blue color filters are separately arranged at three adjacent pixels. The display controller 29b treats each three adjacent pixels as one unit. For example, when the color of a unit is to be red, the white particles are accumulated on the side near the upper electrode 106 in the microcapsules at the red pixel of the unit, and the black particles are accumulated on the same side at the green and blue pixels of the unit. Each unit appears in various colors by adjusting the combination in gray scales of the red, green, and blue pixels including the unit.

The display unit 100b may use another type of electric paper. Alternatively, the display unit 100b may use other types of display devices that display images only during when receiving power. In this case, the card holder 13 comprises a power supply configured to provide the house card 100 with power. Here, the card holder 13 may wirelessly transmit power to the house card 100. The display unit 100b cannot only maintain images but also maximize its performance by using the sufficiently high power received from the card holder 13.

The above-described hardware components of the main control board 20 and the sub-control board 30 mainly configure the following functional units of the gaming machine 1 shown in FIG. 1. That is, the gaming system includes a credit memory unit 71, a sub-credit memory unit 72, a console unit 73, a game controller unit 74, a holder unit 75, a server interface unit 76, a reader unit 77, a sub-credit data processor unit 78, a credit manager unit 79, a point memory unit 80, a point manager unit 81, a point data processor unit 82, a display controller unit 83, and a game display unit 84.

The credit memory unit 71 preferably utilizes the main RAM 23, and stores credit data in a specific area in the main RAM 23. The credit data indicates the amount of credits available to a player.

The sub-credit memory unit 72 preferably utilizes the sub-RAM 33, or alternatively the main RAM 23, and stores sub-credit data into a specific area in the sub-RAM 33 or the main RAM 23. The sub-credit data indicates the amount of sub-credits of a player, which is not allowed to be directly used to play games in contrast to credits. When being short of credits, a player can use sub-credits to increase the credits instead of inserting cash into the gaming machine 1.

The main CPU 21, the main ROM 22, the main RAM 23, and the sub-RAM 33 constitute an example of the credit manager unit 79. The credit manager unit 79 updates the credit data and the sub-credit data to transfer a predetermined amount from the sub-credits to the credits, and vice versa.

The point memory unit 80 preferably utilizes the sub-RAM 23, or alternatively the main RAM 23, and stores point data into another specific area in the sub-RAM 33 or the main RAM 23. The point data indicates the number of points provided to a player depending on the credits that the player has used as bets.

The sub-CPU 31, the sub-ROM 32, and the sub-RAM 33 constitute an example of the point manager unit 81. The point manager unit 81 updates the point data to increase the points by the number that the game controller unit 74 has determined depending on the game plays.

The spin button 6a, the cash out button 6b, the various bet buttons 7, the operational buttons 13c, and the second I/O port 21b constitute an example of the console unit 73. In addition, a touch panel mounted on the monitor 11 or the sub-monitor 14 (not shown in figures) may further constitute the console unit 73. When a player pushes one of the buttons, the console unit 73 then transmits a corresponding operation signal from the second I/O port 21b to the main CPU 21. In particular, bet signals and instructions for updating data or increasing credits are transmitted when the bet buttons 7 and the operational buttons 13c has been pushed, respectively.

The main CPU 21, the main ROM 22, and the main RAM 23 constitute an example of the game controller unit 74. The game controller unit 74 functions according to a game program that the main CPU 21 invokes from the main ROM 22. The game controller unit 74 changes game status in response to instructions that the console unit 73 has accepted. In addition, the game controller unit 74 provides image data for a game screen and visual effects to the video driver 25 and the display controller 29b depending on the game status, and causes them to reproduce the image data on the monitor 11 and the display unit 100b, respectively. The game controller unit 74 also provides data for sound effects to the sound controller 27 depending on game status, and causes it to reproduce the sound effects through the speaker 15. The game controller unit 74 in particular updates the credit data to decrease the amount of credits by the amount of a bet at the start of a game, and increase the amount of credits by a payout provided to a player depending on a bet and game result. The game controller unit 74 also determines the number of points to be provided to a player depending on game plays, in particular, the credits that the player has used as bets.

The holder unit 75 comprises the card holder 13 and utilizes the second I/O port 21b, to control data exchanges between the main control board 20 and the units 100a, 100b of the house card 100 placed in the card slot 13a of the card holder 13.

The main CPU 21, the main ROM 22, the main RAM 23, and the third I/O port 21c constitute an example of the server interface unit 76. The server interface unit 76 controls communication between the main control board 20 and the server 50 through the communications network. The server interface unit 76 in particular transmits requests for auxiliary credit data or total point data to the server 50, and then receives the requested auxiliary credit data and/or total point data from the server 50.

The sub-CPU 31, the sub-ROM 32, the sub-RAM 33, and the card reader/writer 29a constitute an example of the reader unit 77. The reader unit 77 reads storage data, in particular the card ID, through the second I/O port 21b from the storage unit 100a of the house card 100.

The sub-CPU 31, the sub-ROM 32, and the sub-RAM 33 constitute an example of a data processor unit. The data processor unit processes the storage contents that the reader unit 77 has read from the storage unit 100a of the house card 100. The functions of the data processor unit are preferably divided into the sub-credit data processor unit 78 and the point data processor unit 82.

The sub-credit data processor unit 78 causes the server interface unit 76 to transmit a request for auxiliary credit data to the server 50. The request includes the card ID read by the reader unit 77. The sub-credit data processor unit 78 also causes the server interface unit 76 to receive the auxiliary credit data from the server 50 in response to the request. The sub-credit data processor unit 78 then updates the sub-credit data stored in the sub-credit memory unit 72 to increase the amount of the sub-credits by the amount that the auxiliary credit data indicates.

The point data processor unit 82 causes the server interface unit 76 to transmit a request for total point data to the server 50. The request includes the card ID read by the reader unit 77. The point data processor unit 82 also causes the server interface unit 76 to receive the total point data from the server 50 in response to the request. The point data processor unit 82 then updates the point data stored in the point memory unit 80 to increase the number of the points by the number that the total point data indicates.

The main CPU 21, the main ROM 22, the main RAM 23, the sub-RAM 33, and the display controller 29b constitute an example of the display controller unit 83. The display controller unit 83 controls the display unit 100b, and in particular, displays the amount of sub-credits and the number of points thereon, preferably when the credit data, the sub-credit data, or the point data has been updated in the credit memory unit 71, the sub-credit memory unit 72, or the point memory unit 80, respectively.

The main CPU 21, the video driver 25, and the monitor 11 constitute an example of the game display unit 84. The game display unit 84 displays a game screen 11a-11d depending on the game status.

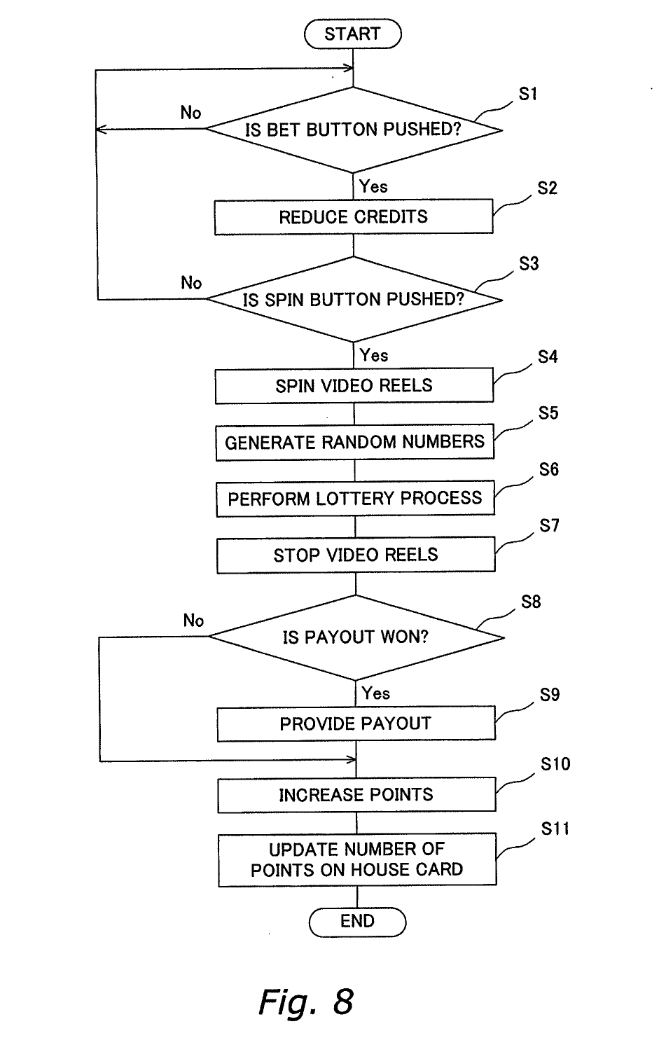

The flow of the processes of a slot game will be described as follows (cf. FIG. 8). First, a player inserts coins or bills into the coin slot 5a or the bill slot 5b, respectively. The coin counter then counts the coins and bills. The credit manager unit 79 updates credit data stored in the credit memory unit 71 to increase credits by the number corresponding to the count of the coin counter.

The player operates the console unit 73 to place a desired bet by using the bet buttons 7 (Step S1). The console unit 73 accepts the placement of the bet, and then the game controller unit 74 updates credit data stored in the credit memory unit 71 to decrease credits by the amount corresponding to the amount of the bet (Step S2). On the other hand, the game controller unit 74 changes the status of the slot game to enable the spin button 6a. More specifically, the game controller unit 74 provides the game display unit 84 with image data of an updated game screen, and then the game display unit 84 displays the updated game screen on the monitor 11, in particular, the amount of the bet on the bet display area 11c thereof, according to the received image data.

After that, the player pushes the spin button 6a. The console unit 73 then detects the push, and transmits a spin signal to the game controller unit 74 (Step S3). The game controller unit 74 then receives the spin signal, and changes the status of the slot game to cause the game display unit 84 to continuously display moving symbols (i.e., spin video reels) on the five symbol display areas 1a of the monitor 11 (Step S4).

At the same time, the game controller unit 74 generates five random numbers, and uses them in a determination of the stop positions of the video reels, i.e., stopped symbols to be displayed on each of the symbol display areas 11a (Step S5). More specifically, the game controller unit 74 compares the five generated random numbers with items in the respective tables (hereinafter, stopped symbol tables) that represent predetermined links between random numbers and symbols. Each stopped symbol table is assigned to one of the symbol display areas 11a. The game controller unit 74 then determines the stop positions of the video reels that indicate symbols linked to the generated random numbers in the stopped symbol tables.

Furthermore, the game controller unit 74 performs a lottery process to determine whether or not to provide an award to the player, i.e., compares the combination of the five random numbers with the items in a table (hereinafter, a winning combination table) that represents predetermined links between combinations of five random numbers and awards (Step S6). The awards are broadly divided into predetermined amounts of credits and rights to play a special game such as an event, a bonus game, a feature game, or the like. If there is an award linked to the combination of the generated random numbers in the winning combination table, the game controller unit 74 then determines that the award is to be provided to the player.

The awards are linked to the combinations of the five random numbers. Each of the random numbers is linked to a stopped symbol in one of the stopped symbol tables. Accordingly, the awards are linked to specific arrangements (i.e., winning combinations) of stopped symbols on the symbol display areas 11a. In this embodiment, preferably, winning combinations are assigned to arrangements where symbols of the same type are stopped in three or more consecutive symbol display areas. Winning combinations that include more symbols of the same type are linked to larger amounts of awards. Needless to say, winning combinations are not limited to the above-described types.

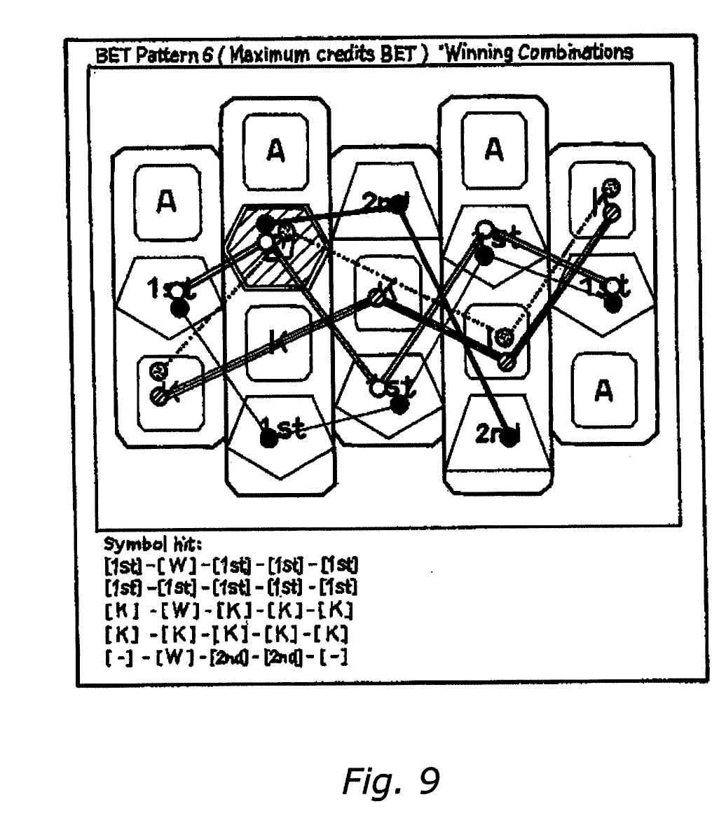

FIG. 9 shows an example of five winning combinations included in an arrangement of stopped symbols displayed on the five symbol display areas 11a (hereinafter, a first, a second, a third, a fourth, and a fifth symbol display area, starting from the left in FIG. 9). A “1st” symbol is stopped in each of the symbol display areas. This arrangement is a winning combination linked to a “1st” award. Here, the amount of the “1st” award linked to the arrangement of the five “1st” symbols is larger than the amounts of the “1st” awards linked to the arrangements where three or four “1st” symbols are stopped in three or four consecutive symbol display areas. A wildcard symbol “W” is stopped in the second symbol display area. The “W” symbol and the four “1st” symbols stopped in the other symbol display areas, which are equivalent to five “1st” symbols”, constitute a winning combination linked to another “1st” award. A “K” symbol is stopped in each of the symbol display areas. This arrangement is a winning combination linked to a “king” award. The “W” symbol and the four “K” symbols stopped in the other symbol display areas, which are equivalent to five “K” symbols”, constitute a winning combination linked to another “king” award. A “2nd” symbol is stopped in each of the third and fourth symbol display areas. The two “2nd” symbols and the “W” symbol, which are equivalent to three “2nd” symbols”, constitute a winning combination linked to a “2nd” award. An “A” symbol is stopped in each of the first and second symbol display areas. However, neither “A” nor “W” symbol is stopped in the third symbol display area. This arrangement is not a winning combination linked to an “ace” award.

After the lottery process and a predetermined time has elapsed from the reception of the spin signal, the game controller unit 74 changes the status of the slot game to cause the game display unit 84 to display the stopped symbols determined by using the above five random numbers on the symbol display areas 11a of the monitor 11 (Step S7). More specifically, the game controller unit 74 provides the game display unit 84 with image data representing changes from the moving symbols to the stopped symbols. The game display unit 84 then changes images displayed on the symbol display areas 11a of the monitor 11 from the moving symbols to the stopped symbols according to the received image data.

If the result of the lottery process is that a player will win a predetermined amount of a payout (Step S8), the game controller unit 74 causes the payout controller 28 to pay the credits to the player (Step S9). More specifically, the game controller unit 74 updates the credit data stored in the credit memory unit 71 to increase the player's credits by the amount of the payout. The game controller unit 74 further provides the lighting controller 26 and the sound controller 27 with commands for controlling lamps and the audio data, respectively. The lighting controller 26 then turns on and off the lamp buttons equipped with internal light emitting devices, e.g., the lamps 10a, 10b, the spin button 6a, the cash out button 6b, and the bet buttons 7 in the patterns represented by the commands. The sound controller 27 changes sounds reproduced from the speaker 15 to the sound effects according to the audio data.

The game controller unit 74 also provides a number of points to a player depending on the credits that the player has spent for the games (Step S10). More specifically, the game controller unit 74 first determines the number of points to be provided to the player depending on the amount of bets. Next, the point manager unit 81 updates the point data to increase the points by the number that the game controller unit 74 has determined. The display controller unit 83 then controls the display unit 100b to display the number of the points thereon (Step S11).

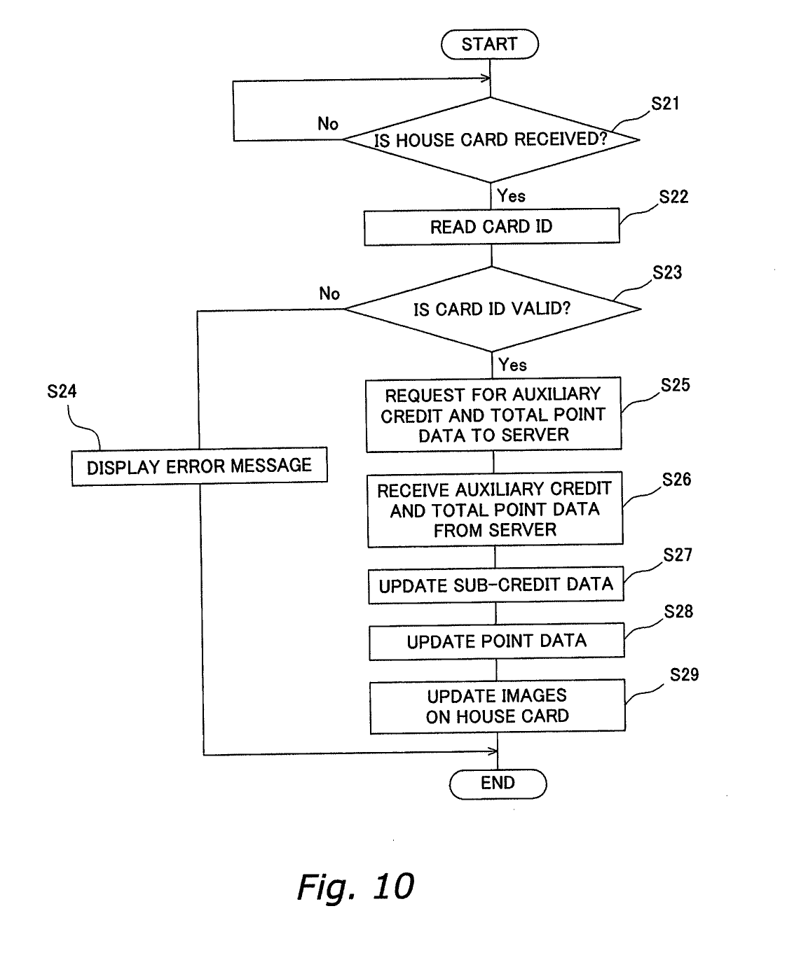

The gaming system of this embodiment of the present invention allows each player to use the amount of the money that he/she has entrusted to the casino in advance as follows (cf. FIG. 10). First, each player has issued a house card 100 before game plays in exchange for registration of his/her personal information to the server 50. The player is then allowed to entrust his/her money to the casino. An operator enters the auxiliary credit data indicating the amount of the money and the personal information into the memory unit 61 of the server 50. The auxiliary credit data and the personal information are linked to the card ID stored in the storage unit 100a of the house card 100 that has been issued to the player. Preferably, the amount of the entrusted money is displayed on the display unit 100b of the house card 100. Note that players may be allowed to increase the entrusted money by using a kiosk terminal. In that case, the card ID stored in the house card 100 may be used to authenticate the players.

Each player places his/her own house card 100 in the card holder 13 before game play on the gaming machine 1 (Step S21). The reader unit 77 then reads the card ID from the storage unit 100a of the house card 100 (Step S22), and sends it to the sub-credit data processor unit 78, which receives and verifies the card ID (Step S23). Note that the server 50 may verify the card ID instead of the sub-credit data processor unit 78. In this case, the sub-credit data processor unit 78 sends the received card ID to the server 50, and then receives the results of the verification from the server 50 as a response to the card ID.

When the card ID is invalid, the sub-credit data processor unit 78 sends a signal indicating the invalidity to the game controller unit 74, which then receives the signal, and commands the display controller unit 83 to display an error message on the display unit 100b of the house card 100 (Step S24). Here, the error message may be displayed on the monitor 11.

When the card ID is valid, the sub-credit data processor unit 78 causes the server interface unit 76 to transmit a request for auxiliary credit data and total point data to the server 50. The receiver unit 62 of the server 50 receives the request, and extracts the card ID from the request. The transmitter unit 63 then retrieves the requested auxiliary credit data and total point data from the memory unit 61 by using the card ID, and transmits them to the gaming machine 1. The server interface unit 76 receives and transfers the auxiliary credit data and the total point data to the sub-credit data processor unit 78 and the point data processor unit 82, respectively (Step S26). The sub-credit data processor unit 78 then updates the sub-credit data stored in the sub-credit memory unit 72 to increase the amount of the sub-credits by the amount that the auxiliary credit data indicates (Step S27). The point data processor unit 82 updates the point data stored in the point memory unit 80 to increase the number of the points by the number that the total point data indicates (Step S28).

The display controller unit 83 then updates the images representing the amount of the sub-credits and the number of the points that are displayed on the display unit 100b by using the data stored in the sub-credit memory unit 72 and the point memory unit 80 (Step S29). Accordingly, the player can check the amount of the available sub-credits and the number of the points through the sub-display window 13b of the card holder 13.

If an error occurs, e.g., the server 50 cannot retrieve the auxiliary credit data or the total point data linked to the card ID from the memory unit 61, the gaming machine 1 is notified of the error through the network. The game controller unit 74 then commands the display controller unit 83 to display an error message on the display unit 100b of the house card 100 in a manner similar to that in the case where the card ID is invalid.

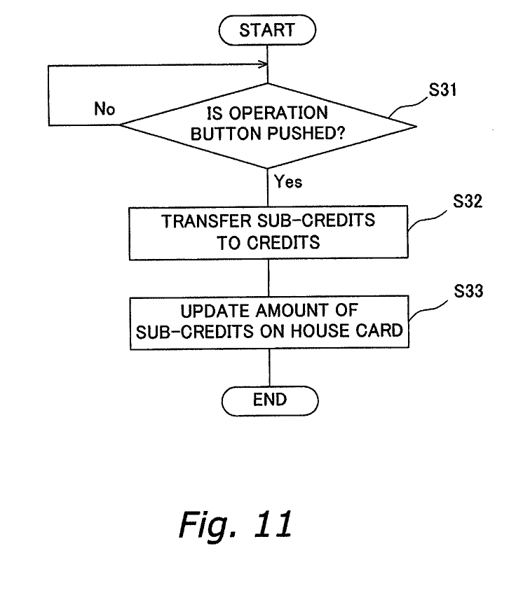

The gaming system of this embodiment of the present invention allows each player to add sub-credits to credits, and then use them to play games as bets as follows (cf. FIG. 11). When the player pushes the operation buttons 13c to add sub-credits to credits, the console unit 73 accepts the pushes (Step S31). The credit manager unit 79 then updates credit data stored in the credit memory unit 71 to increase credits by the amount of sub-credits indicated by the sub-credit data stored in the sub-credit memory unit 72. The credit manager unit 79 further clears the sub-credit data to decrease sub-credits to be zero (Step S32). After that, the display controller unit 83 changes the number representing the amount of the sub-credits to be zero on the display unit 100b (Step S33).

Preferably, the amount of the sub-credits is automatically displayed on the display unit 100b when a player has inserted his/her house card 100 into the card slot 13a. Alternatively, the portion or entirety of the sub-credits may be automatically added to the credits when a player has inserted his/her house card 100 into the card slot 13a.

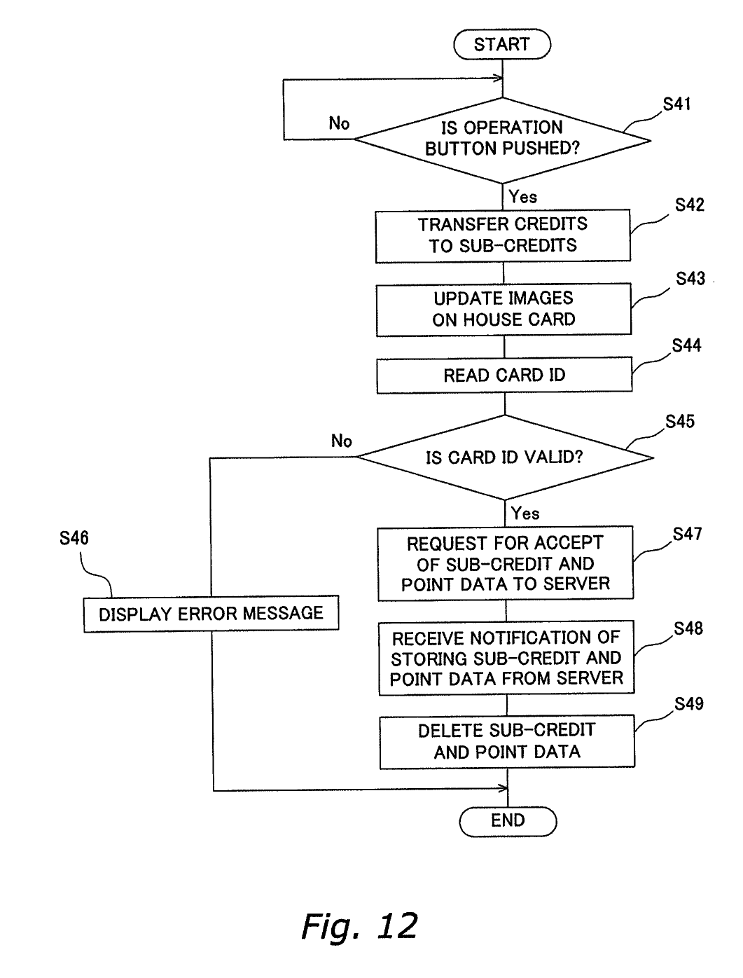

The gaming system of this embodiment of the present invention allows each player to transfer credit data and point data from the gaming machine 1 to the server 50 as follows (cf. FIG. 12). When the player pushes the operation buttons 13c to transfer the credit data and the point data, the console unit 73 accepts the pushes (Step S41). The credit manager unit 79 then updates the sub-credit data stored in the sub-credit memory unit 72 to increase sub-credits by the amount of credits indicated by the credit data stored in the credit memory unit 71. The credit manager unit 79 further clears the credit data to decrease credits to be zero (Step S42). After that, the display controller unit 83 displays the number representing the amount of the sub-credits, i.e., the credits retained in the gaming machine 1, on the display unit 100b (Step S43). Moreover, the reader unit 77 transfers the card ID from the storage unit 100a of the house card 100 to the sub-credit data processor unit 78 (Step S44). The sub-credit data processor unit 78 then verifies the card ID in the above-described manner (Step S45).

When the card ID is invalid, the sub-credit data processor unit 78 sends a signal indicating the invalidity to the game controller unit 74, which receives the signal, and then commands the display controller unit 83 to display an error message on the display unit 100b of the house card 100 (Step S46).

When the card ID is valid, the sub-credit data processor unit 78 causes the server interface unit 76 to transmit a request for accepting the sub-credit data and the point data to the server 50 (Step S47). The receiver unit 62 of the server 50 receives the request, and extracts the card ID, the sub-credit data, and the point data from the request. The receiver unit 62 then stores the sub-credit data and the point data into the memory unit 61, and links them to the card ID. The transmitter unit 63 then notifies the gaming machine 1 of storing the sub-credit data and the point data. The server interface unit 76 receives and transfers the notification to the sub-credit data processor unit 78 and the point data processor unit 82 (Step S48). The sub-credit data processor unit 78 then deletes the sub-credit data stored in the sub-credit memory unit 72, and the point data processor unit 82 deletes the point data stored in the point memory unit 80 (Step S49).

On the display unit 100b, the amount of the sub-credits and the number of the points are displayed which correspond to the sub-credit data and the point data stored in the memory unit 61 of the server 50. Preferably, the display unit 100b comprises a piece of electric paper, and accordingly can maintain images after it has been removed from the card holder 13. Thus, players can check their credits and points on the display units 100b of their own house cards 100 on the move within the casino. Alternatively, the player can check their credits and points on the display units 100b when they have placed the house cards 100 in card holders 13 on the gaming machines 1.

Note that players may instruct the credit manager unit 79 to integrate the amounts of credits and sub-credits into sub-credits, and separately instruct the sub-credit data processor unit 78 to transfer sub-credit data to the server 50. In addition, sub-credit data and point data may be separately transmitted to the server 50.

As described above, the display controller unit 83 can continue to display the latest amount of the sub-credits and the latest number of the points on the display unit 100b of the house card 100, while the house card 100 is placed in the card holder 13. The display controller unit 83 can also display various notifications and error messages on the display unit 100b.

The amounts of payouts and jackpot values that players have won may be displayed on the display unit 100b. In particular, the house card displayed on the amounts of payouts and jackpot values may be provided to the players, when they have won the payouts and the jackpots, instead of the tickets and checks on which the amounts of payouts and jackpot values are printed.

Welcome messages and the likes may be displayed on the display unit 100b, instead of the sub-monitor 14. This may allow the sub-monitor 14 to be removed from the gaming machine 1, and thereby reduce the production cost of the gaming machine 1.

The gaming machine 1 preferably comprises an image scanner unit and an image processor unit. The image scanner unit is configured to scan at least a portion of images from the screen of the display unit 100b while the house card 100 is placed in the card holder 13. The image processor unit is configured to process the image data captured by the image scanner unit, and in particular, check if the images include an error, preferably at each time when the display controller unit 83 updates the images on the display unit 100b. Accordingly, if the display unit 100b fails to display or update the amount of sub-credits or the number of points thereon, the image processor unit can immediately notify a player and casino attendants of the failure. The gaming machine 1 can thus ensure high reliability and security of the images displayed on the display unit 100b.

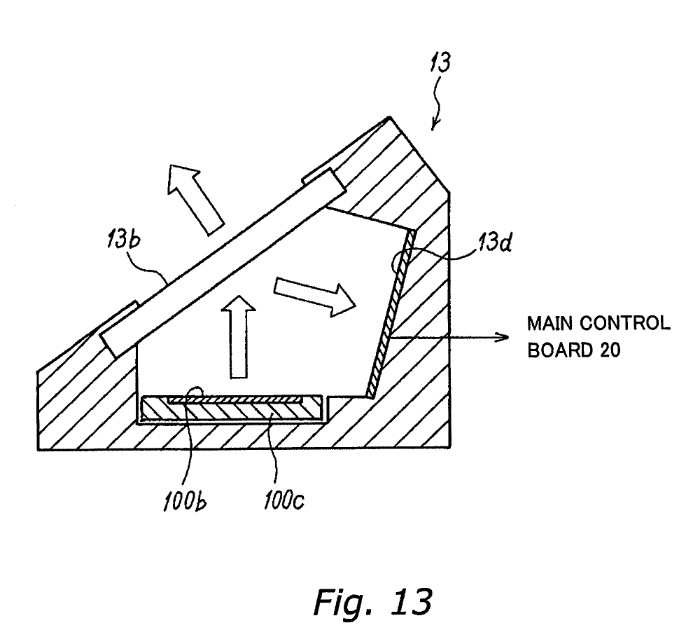

The main CPU 21, the main ROM 23, the main RAM 23 (cf. FIG. 4), and an image sensor 13d (preferably, a CCD camera) shown in FIG. 13 constitute an example of the image scanner unit. Referring to FIG. 13, the house card 100 is placed in a horizontal position in the card holder 13. The screen of the display unit 100b opposes the transparent sub-display window 13b at the top of the card holder 13. Since a portion of the rays of light reflected on the screen passes through the sub-display window 13b, the screen is visible to the player. Another portion of the reflected rays is further reflected on the inner surface of the sub-display window 13b, and then absorbed and converted into electric signals at the image sensor 13d. The signals are transmitted from the image sensor 13d to the main CPU 21. Then, the image data is decoded from the signals.

The main CPU 21, the main ROM 23, and the main RAM 23 (cf. FIG. 4) constitute an example of the image processor unit. The image processor unit receives the image data from the image scanner unit, and then compares the image data with one that the display controller unit 83 has provided to the display unit 100b. If both image data match each other, the image processor unit determines that no error has occurred. Otherwise, the image processor unit determines that an error has occurred, and then ejects the house card 100 from the card holder 13 and displays a message on the monitor 11. The message urges the player to reset the house card 100 into the card holder 13. When the house card 100 has been reset into the card holder 13, the image processor unit then causes the display controller unit 83 to display images on the display unit 100b. If the error has still occurred, the image processor unit aborts the game controller unit 74, and notifies casino attendants of the error.

The image processor unit may use the image data captured by the image scanner unit in other processes, e.g., authentication of players and house cards, and reproduction of images on the monitor 11. The image data undergoing the processes may represent letters, numbers, symbols, diagrams, pictures, a bar code, and a matrix code that are displayed on the display unit 100b and indicate the player ID, the card ID, the individual information of a player (e.g., his/her name and a photograph of the player), and/or the auxiliary credits of the player. The image processor unit can decode the auxiliary credits from the captured image data in addition to the storage contents read from the storage unit 100a, such as monetary information printed on a ticket used in a ticket-in system. The image processor unit can also perform another authentication process instead of or in parallel to the sub-credit data processor unit 78, e.g., use the photograph of the player in face authentication. Note that only the images to be used by the image processor unit may be displayed on the display unit 100b, i.e., the images may not include the amount of sub-credits and the number of points. In this case, the display controller unit may be eliminated from the gaming machine 1.

In the above-described embodiment, the gaming machine 1 is a video slot machine. Alternatively, the present invention may be embodied as other types of gaming machines, e.g., stepper slot machines having mechanical reels. In the above-described embodiment, the gaming machine 1 is installed in a casino. Alternatively, the present invention may be embodied as gaming machines installed in other places, e.g., amusement arcades, pachinko parlors, or houses.

### General Interpretation of Terms

In understanding the scope of the present invention, the term “configured” as used herein to describe a component, section or portion of a device includes hardware and/or software that is constructed and/or programmed to carry out the desired function. In understanding the scope of the present invention, the term “comprising” and its derivatives, as used herein, are intended to be open ended terms that specify the presence of the stated features, elements, components, groups, integers, and/or steps, but do not exclude the presence of other unstated features, elements, components, groups, integers and/or steps. The foregoing also applies to words having similar meanings such as the terms, “including”, “having” and their derivatives. Also, the terms “unit,” “section,” “portion,” “member” or “element” when used in the singular can have the dual meaning of a single portion or a plurality of portions. Finally, terms of degree such as “substantially”, “about” and “approximately” as used herein mean a reasonable amount of deviation of the modified term such that the end result is not significantly changed. For example, these terms can be construed as including a deviation of at least ±5% of the modified term if this deviation would not negate the meaning of the word it modifies.

While only a preferred embodiment has been chosen to illustrate the present invention, it will be apparent to those skilled in the art from this disclosure that various changes and modifications can be made herein without departing from the scope of the invention as defined in the appended claims. Furthermore, the foregoing description of the preferred embodiment according to the present invention is provided for illustration only, and not for the purpose of limiting the invention as defined by the appended claims and their equivalents.

What is claimed is:

1. A gaming machine comprising:
a game controller unit configured to conduct a game;
a holder unit configured to removably hold a portable storage device having a display unit and a storage unit in a position where a screen of the display unit is visible to a player;
a reader unit configured to read storage contents from the storage unit; and
a data processor unit configured to process the storage contents.

2. A gaming machine according to claim 1 further comprising
a game display unit configured to display a game screen.

3. A gaming machine according to claim 1 further comprising
a display controller unit configured to control the display unit to change images displayed on the screen of the display unit depending on the game status.

4. A gaming machine according to claim 1 further comprising
a power supply unit configured to provide the portable storage device with power.

5. A gaming machine according to claim 1 further comprising
an image scanner unit configured to scan at least a portion of images from the screen of the display unit; and
an image processor unit configured to process image data captured by the image scanner unit.

6. A gaming machine according to claim 5 further comprising
a display controller unit configured to control the display unit, wherein the image processor unit is configured to detect an error in images displayed on the screen of the display unit from the image data captured by the image scanner unit.

7. A gaming machine according to claim 1 further comprising
a console unit configured to accept a bet from a player;
a credit memory unit configured to store credit data that indicates an amount of credits, the credit data being updated by the game controller unit by decreasing the amount of credits by the amount of a bet at the start of a game or increasing the amount of credits by a payout provided to the player depending on the amount of the bet and the game result;
a sub-credit memory unit configured to store sub-credit data that indicates an amount of sub-credits;
a credit manager unit configured to update the credit data and the sub-credit data to transfer a predetermined amount from the sub-credits to the credits; and
a display controller unit configured to cause the display unit to display the amount of sub-credits.

8. A gaming machine according to claim 7 further comprising
a server interface unit configured to communicate with a server, wherein
the reader unit is configured to read identification data from the storage unit,
the data processor unit is configured to cause the server interface unit to transmit the identification data to the server and receive auxiliary credit data from the server in response to the identification data, and
the data processor unit is configured to update the sub-credit data to increase the amount of the sub-credits by the amount that the auxiliary credit data indicates.

9. A gaming machine according to claim 1 further comprising
a point memory unit configured to store point data indicating a number of points; and
a point manager unit configured to update the point data to increase the points by a number that the game controller unit has determined depending on the game plays; and
a display controller unit configured to cause the display unit to display the number of the points.

10. A gaming machine according to claim 9 further comprising
a server interface unit configured to communicate with a server, wherein
the reader unit is configured to read identification data from the storage unit,
the data processor unit is configured to cause the server interface unit to transmit the identification data to the server and receive total point data from the server in response to the identification data, and
the data processor unit is configured to update the point data to increase the number of points by a number that the total point data indicates.

11. A gaming system comprising:
a portable storage device including a display unit and a storage unit; and
a gaming machine including
a game controller unit configured to conduct a game,
a holder unit configured to removably hold the portable storage device in a position where the screen of the display unit is visible to a player,
a reader unit configured to read storage contents from the storage unit, and
a data processor unit configured to process the storage contents.

12. A gaming system comprising:
a server and a gaming machine configured to communicate with each other,
the server or the gaming machine including a game controller unit configured to conduct a game on the gaming machine and provide a payout or a bonus to a player depending on a bet and the game result,
the server including
a memory unit configured to store auxiliary credit data linked to identification data,
a receiver unit configured to receive identification data from the gaming machine, and
a transmitter unit configured to retrieve from the memory unit the auxiliary credit data linked to the identification data that the receiver unit has received, and transmit the auxiliary credit data to the gaming machine,
the gaming machine including
a console unit configured to accept a bet from a player,
a credit memory unit configured to store credit data that indicates an amount of credits, the credit data being updated by the game controller unit by decreasing the amount of credits by the amount of the bet at the start of the game, or increasing the amount of credits by a payout provided to the player depending on the bet and the game result,
a sub-credit memory unit configured to store sub-credit data that indicates an amount of sub-credits,
a credit manager unit configured to update the credit data and the sub-credit data to transfer a predetermined amount from the sub-credits to the credits,
a server interface unit configured to communicate with the server,
a holder unit configured to removably hold a portable storage device having a display unit and a storage unit in a position where a screen of the display unit is visible to the player,
a reader unit configured to read identification data from the storage unit,
a data processor unit configured to cause the server interface unit to transmit the identification data read by the reader unit to the server and receive the auxiliary credit data linked to the identification data from the server in response to the identification data, the data processor unit being further configured to update the sub-credit data to increase the amount of sub-credits by the amount that the auxiliary credit data indicates, and
a display controller unit configured to cause the display unit to display the amount of sub-credits.

13. A gaming system comprising:
a server and a gaming machine configured to communicate with each other,
the server or the gaming machine including a game controller unit configured to conduct a game on the gaming machine and provide a payout or a bonus to a player depending on a bet and the game result,
the server including
a memory unit configured to store total point data linked to identification data,
a receiver unit configured to receive identification data from the gaming machine, and
a transmitter unit configured to retrieve from the memory unit the total point data linked to the identification data that the receiver unit has received, and transmit the total point data to the gaming machine,
the gaming machine including
a point memory unit configured to store point data indicating a number of points,
a point manager unit configured to update the point data to increase the points by a number that the game controller unit has determined depending on the game plays,
a server interface unit configured to communicate with the server,
a holder unit configured to removably hold a portable storage device having a display unit and a storage unit in a position where a screen of the display unit is visible to a player,
a reader unit configured to read identification data from the storage unit,
a data processor unit configured to cause the server interface unit to transmit the identification data to the server and receive total point data linked to the identification data from the server in response to the identification data, the data processor unit being further configured to update the point data to increase the number of points by a number that the total point data indicates, and
a display controller unit configured to cause the display unit to display the number of points.
